(19) United States
(12) Patent Application Publication
(10) Pub. No.: US 2015/0330337 A1
(43) Pub. Date: Nov. 19, 2015

(54) FUEL VAPOR PROCESSING APPARATUS

(71) Applicant: AISAN KOGYO KABUSHIKI KAISHA, Obu-shi (JP)

(72) Inventors: Naoyuki TAGAWA, Nagoya-shi (JP); Yoshikazu MIYABE, Obu-shi (JP); Minoru AKITA, Ama-shi (JP)

(73) Assignee: AISAN KOGYO KABUSHIKI KAISHA, Obu-shi (JP)

(21) Appl. No.: 14/707,158

(22) Filed: May 8, 2015

(30) Foreign Application Priority Data
May 13, 2014 (JP) 2014-099404

(51) Int. Cl. F02M 25/08; F02D 41/00

(52) U.S. Cl. CPC F02M 25/0809; F02M 25/0836; F02M 25/0854; F02D 41/003

(57) ABSTRACT

A fuel vapor processing apparatus may include a vapor passage connecting a canister and a fuel tank of an engine system. An opening and closing valve may be disposed in the vapor passage. A valve opening device may be coupled to the opening and closing valve and may forcibly open the valve when the internal pressure of the fuel tank detected by a pressure has reached to a set pressure value.

### CROSS-REFERENCE TO RELATED APPLICATIONS

This application claims priority to Japanese patent application serial number 2014-099404 filed May 13, 2014, the contents of which are incorporated herein by reference in their entirety for all purposes.

### STATEMENT REGARDING FEDERALLY SPONSORED RESEARCH OR DEVELOPMENT

Not applicable.

### BACKGROUND

1. Technical Field

Embodiments of the present disclosure relate to fuel vapor processing apparatus used in systems for supplying fuel from fuel tanks to engines, such as vehicle engines.

2. Background Art

Japanese Laid-Open Patent Publication No. H08-74678 discloses a pressure regulating valve used in a fuel vapor processing system in which fuel vapor produced within a fuel tank is purged to an engine. The pressure regulating valve may adjust the internal pressure of the fuel tank within a predetermined range between an upper limit value and a lower limit value.

The pressure regulating valve may include a diaphragm and it may be possible that the pressure regulating valve may not properly function if the diaphragm is failed. If the pressure regulating valve does not properly operate, the internal pressure of the fuel tank may not be properly regulated, resulting in that the internal pressure may become out of the predetermined range.

There has been a need in the art for techniques of preventing an internal pressure of a fuel tank from becoming out of a predetermined range even in the case that a pressure regulating valve does not properly function.

### SUMMARY

In one aspect according to the present disclosure, a fuel vapor processing apparatus for use with an engine system may include a canister, a vapor passage, a purge passage, an opening and closing valve, a pressure sensor and a valve opening and closing device. The vapor passage may connect the canister and a fuel tank of the engine system, so that fuel vapor produced in the fuel tank can be adsorbed by the canister via the vapor passage. The purge passage may connect the canister and an engine body of the engine system, so that fuel vapor adsorbed from the canister can be purged to the engine body via the purge passage. The opening and closing valve may be disposed in the vapor passage and may open and close the vapor passage. The pressure sensor may be coupled to the fuel tank and may detect an internal pressure of the fuel tank. The valve opening device may be coupled to the opening and closing valve and may open the opening and closing valve when the internal pressure of the fuel tank detected by the pressure sensor has reached to a first set pressure value that is determined to prevent potential damage to the fuel tank.

With this arrangement, even in the case that a pressure adjusting valve that adjusts the internal pressure of the fuel tank does not properly operate, it may be possible to prevent the internal pressure of the fuel tank from changing beyond the first set pressure value. The first set pressure value may be a maximum set value or a minimum set value. If the first set pressure value is the maximum set value, the internal pressure of the fuel tank may be prevented from increasing beyond the first set value. On the other hand, if the first set pressure value is the minimum set value, the internal pressure of the fuel tank may be prevented from decreasing beyond the first set value.

The fuel vapor processing apparatus may further include a failure determination device that may determine whether or not the pressure sensor is properly operating based on whether or not a detected pressure of the pressure sensor has changed to decrease a pressure difference between the detected pressure of the fuel tank and the atmospheric pressure. The failure determination device may determine that the pressure sensor is properly operating if a detected pressure of the pressure sensor has changed to decrease a difference between the detected pressure and an atmospheric pressure in response to opening of the opening and closing valve by the valve opening device. The failure determination device may determine that the pressure sensor does is not properly operating if the detected pressure of the pressure sensor has not changed to decrease the difference between the detected pressure and the atmospheric pressure in response to opening of the opening and closing valve by the valve opening device.

The pressure sensor may have a detectable range between an upper limit value and a lower limit value. The first set pressure may be determined to be within the detectable range and may not be equal to the upper limit value and the lower limit value.

With this arrangement, when the detected pressure of the fuel tank reaches to the first set pressure, the opening and closing valve may be opened to release the pressure within the fuel tank. By determining the first set pressure to be within the detectable range and to be not equal to the upper limit value and the lower limit value, the internal pressure may not exceed the upper limit value of the detectable range or may not be lowered below the lower limit value. Therefore, the internal pressure can be always detected by the pressure sensor and may be always used for the other controls, such as a fuel injection control. For example, if another parameter other than the internal pressure of the fuel tank is used for the fuel injection control, the control process of the fuel injection control may be complicated. In this way, it is possible to avoid a complicated control process of the fuel injection control and other controls that use the internal pressure as a parameter.

With the first set pressure determined to be within the detectable range of the pressure sensor and not to be equal to the upper limit value or the lower limit value, a failure determination device may configured to determine whether or not the pressure sensor is properly operating. The failure determination device may determine that the pressure sensor is properly operating if a detected pressure of the pressure sensor has changed from a second set pressure to decrease a pressure difference between the detected pressure and an atmospheric pressure when a predetermined time has elapsed after the opening and closing valve has been opened. The failure determination device may determine that the pressure sensor is not properly operating if the detected pressure of the pressure sensor has not changed from the second set pressure to decrease the pressure difference between the detected pressure and the atmospheric pressure when the predetermined time has elapsed after the opening and closing valve has been opened. The second set pressure may be nearer to the atmospheric pressure than the first set pressure.

By using the second set pressure as a reference for determining the failure of the pressure sensor and determining the failure when the predetermined time has elapsed after opening the opening and closing valve, it may be possible to quickly and efficiently determine where or not the pressure sensor is properly operating.

A controller serving as the valve opening device and/or the failure detection device may be coupled to the pressure sensor and the valve.

### BRIEF DESCRIPTION OF THE DRAWINGS

FIG. 1 is a schematic block diagram showing a general concept of a fuel vapor processing apparatus according to a first embodiment;

FIG. 2 is a schematic view of a vehicle engine system incorporating the fuel vapor processing apparatus;

FIG. 3 is a flowchart showing a valve opening process routine performed by an ECU of the fuel vapor processing apparatus;

FIG. 4 is a flowchart showing a valve opening process routine including a failure determination process for determining a failure of a pressure sensor, performed by an ECU of a fuel vapor processing apparatus according to a second embodiment;

FIG. 5 shows time charts illustrating the valve opening process performed according to the first embodiment and also illustrating the valve opening process and the failure determination process performed according to the second embodiment; and

FIG. 6 is a flowchart showing a valve opening process routine including a failure determination process for determining a failure of a pressure sensor, performed by an ECU of a fuel vapor processing apparatus according to a third embodiment.

### DETAILED DESCRIPTION

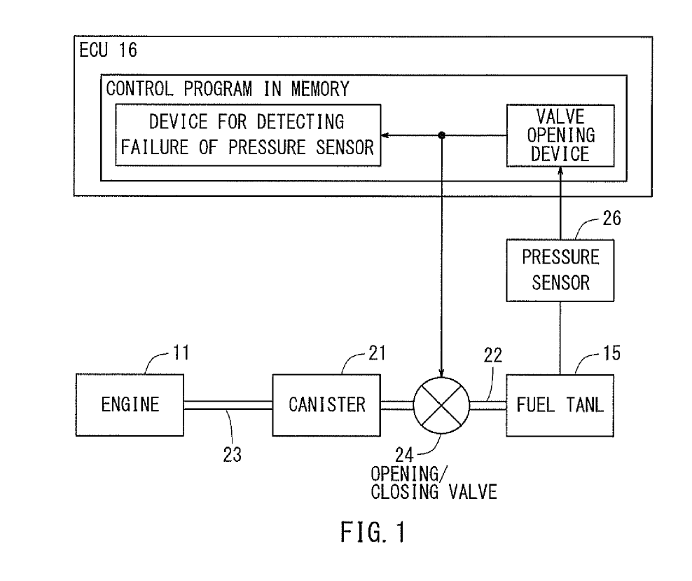

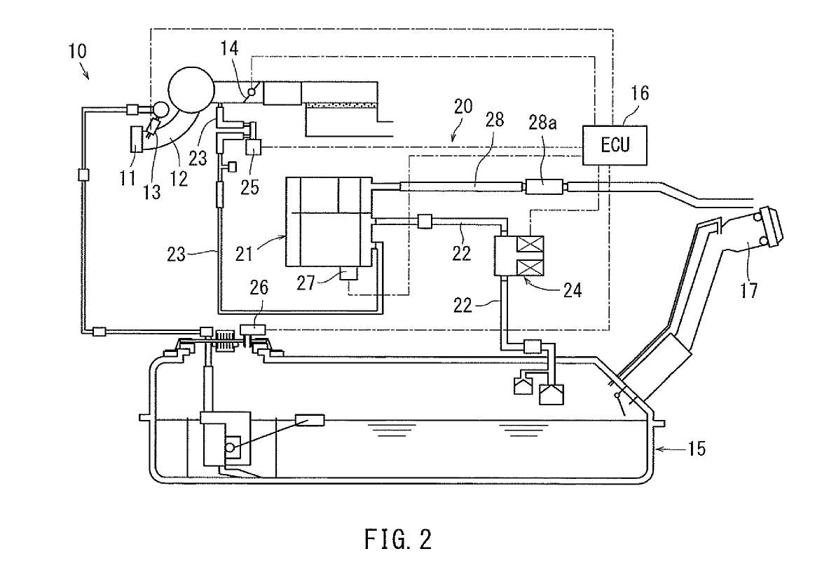

A first embodiment will now be described with reference to FIGS. 1, 2 and 3. Referring to FIG. 1, there is shown a schematic block diagram showing a general concept of a fuel vapor processing apparatus 20 according to a first embodiment. The fuel vapor processing apparatus 20 may be used for a vehicle engine system 10 as shown in FIG. 2.

Referring to FIG. 2, the vehicle engine system 10 may be configured to supply a mixture of air and fuel to an engine body 11 that may be an engine body of an internal combustion engine of a vehicle, such as an automobile. A throttle valve 14 may be disposed in an intake passage 12 and may control the flow rate of air supplied to the engine body 11. A fuel injection valve 13 may inject fuel into the intake passage 12, so that the fuel can be mixed with air before being supplied to the engine body 11. The throttle valve 14 and the fuel injection valve 13 may be electrically connected to an ECU (electronic control unit) 16. The ECU 16 may receive an open degree signal representing a degree of opening of the throttle valve 14. The ECU 16 may control a valve opening time of the fuel injection valve 13 according to the open degree signal and other related signals as will be described later. The ECU 16 may be a controller including a processor coupled to a memory. The memory may include a control program which is executable by the processor. The ECU 16 may perform various controls according to the control program as will be described later. The fuel may be supplied from a fuel tank 15 to the fuel injection valve 13 while a pressure of the fuel may be regulated to a predetermined value before being supplied to the fuel injection valve 13.

The fuel vapor processing apparatus 20 may include a canister 21 and a vapor passage 22. The vapor passage 22 may connect the fuel tank 15 and the canister 21, so that the canister 21 can adsorb fuel vapor that may be produced within the fuel tank 15. The fuel vapor processing apparatus 20 may further include a purge passage 23 that connects the canister 21 to the intake passage 12 at a position on a downstream side of the throttle valve 14, so that fuel vapor desorbed from the canister 21 can be supplied to the intake passage 12 during a purge operation. An opening and closing valve 24 may be disposed in the vapor passage 22 and may open and close the vapor passage 22. The opening and closing valve 24 may include a step motor (not shown) that may be driven to open and close the opening and closing valve 24. A purge valve 25 may be disposed in the purge passage 23 and may open and close the purge passage 23. Adsorbent, such as activated carbon (not shown) may be contained in the canister 21. The adsorbent may adsorb fuel vapor supplied from the vapor passage 22 and may allow desorption of adsorbed fuel vapor. The desorbed fuel vapor may flow into the purge passage 23. The fuel vapor processing apparatus 20 may further include an atmospheric passage 28 that connects the canister 21 to the atmosphere. A negative pressure may be produced in the intake passage 12 as the engine body 11 is driven. The negative pressure thus produced may be applied to the canister 21 via the purge passage 23 while the atmospheric air may be introduced into the atmospheric passage 28. Therefore, the fuel adsorbed by the canister 21 may be desorbed and may be supplied to the engine body 11 via the purge passage 23 and the intake passage 12. In this way, a fuel vapor purge operation can be performed. The atmospheric passage 28 may be opened to the atmosphere at a position proximal to a fuel filler pipe 17 connected to the fuel tank 15. An air filter 28a may be disposed in the atmospheric passage 28.

In order to control the valve opening time of the fuel injection valve 13 according to the control program, the ECU 16 may receive various control signals including the open degree signal of the throttle valve 14 described above. For example, the control signals may include a pressure detection signal from a pressure sensor 26 that detects the internal pressure of the fuel tank 15, and a temperature detection signal from a temperature sensor 27 that detects the temperature of the canister 21. In addition to the control of the valve opening time of the fuel injection valve 13, the ECU 16 may perform various controls such as valve opening/closing controls of the opening and closing valve 24 and the purge valve 25. In this embodiment, the opening and closing valve 24 may be normally closed and may be opened, for example, during refueling to the fuel tank 15 based on a signal from a refueling sensor (not shown). In addition, the opening and closing valve 24 may be forcibly opened as will be hereinafter described.

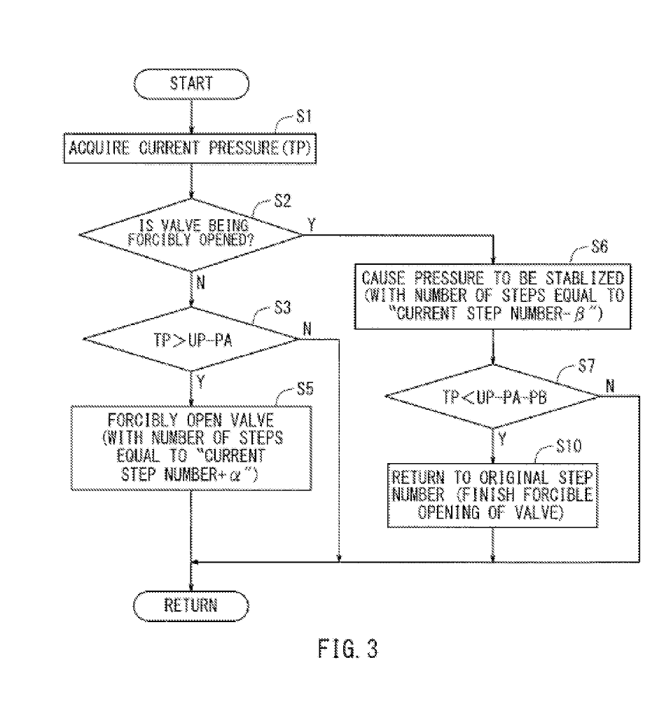

A valve opening process routine of the valve opening/closing control of the opening and closing valve 24 will now be described with reference to FIG. 3. In step S1, a pressure value TP of the current pressure detected by the pressure sensor 26 may be acquired. Next, in Step S2, it is determined whether or not a forcible valve opening operation is being performed. If the determination is “NO”, the process proceeds to Step S3 in which it is determined whether or not the pressure value TP of the current pressure is larger is than a first set pressure value. The first set pressure value may be smaller than an upper limit pressure value UP of the pressure sensor 26 by a first predetermine value PA. The upper limit pressure value UP may be an upper limit pressure value detectable by the pressure sensor 26. The first set pressure value may be determined to be small enough to prevent potential damage to the fuel tank 15. If the determination in Step S3 is “NO”, the process returns to “START” of the next cyclic process. On the other hand, if the determination in Step S3 is “YES”, the process proceeds to Step S5 in which the opening and closing valve 24 is forcibly opened. More specifically, the step motor of the opening and closing valve 24 is driven by a first predetermined number α of steps in a valve opening direction, so that the closing valve 24 is positioned at a fully opened position. The fully opened position may correspond to the first predetermined number α added to a current number of steps corresponding to the current position of the closing valve 24. In this specification, the number of steps is used to mean the number of steps of the step movement in the opening direction of the step motor counted from a reference position that may be a fully closed position. As the number of steps increases, the degree of opening of the opening and closing valve 24 may gradually increases. After Step S5, the process returns to “START” of the next cyclic process.

In the next cyclic process, the determination in Step S2 may be “YES”, so that the process proceeds to Step S6 in which the valve opening amount of the closing valve 24 may be reduced by a small value for stabilizing the internal pressure of the fuel tank 15. More specifically, the step motor of the closing valve 24 is driven by a second predetermined number β of steps in a valve closing direction. In other words, the closing valve 24 may be moved to a position corresponding to subtraction of the second predetermined number β from the current number of steps that corresponds to the current position of the closing valve 24. In this way, the valve opening degree of the closing valve 24 is largely increased in Step S5 and is thereafter reduced in Step S6. By largely increasing the valve opening degree in Step S5, it may be possible to quickly reduce the internal pressure of the fuel tank 15. By reducing the valve opening degree in Step S6, the internal pressure of the fuel tank 15 may be stabilized without being excessively lowered.

The process may proceed from Step S6 to Step S7 in which it is determined whether or not the pressure value TP detected by the pressure sensor 26 is smaller than a second set pressure value. The second set pressure value may be a subtraction of the sum of the first predetermined value PA and a second predetermined value PB from the upper limit value UP. If the determination in Step S7 is “NO”, the process returns to “START” of the next cyclic process. On the other hand, if the determination in Step S7 is “YES”, the process proceeds to Step S10 in which the number of steps set in Step S6 may be returned to the original number of steps before being increased in Step S5.

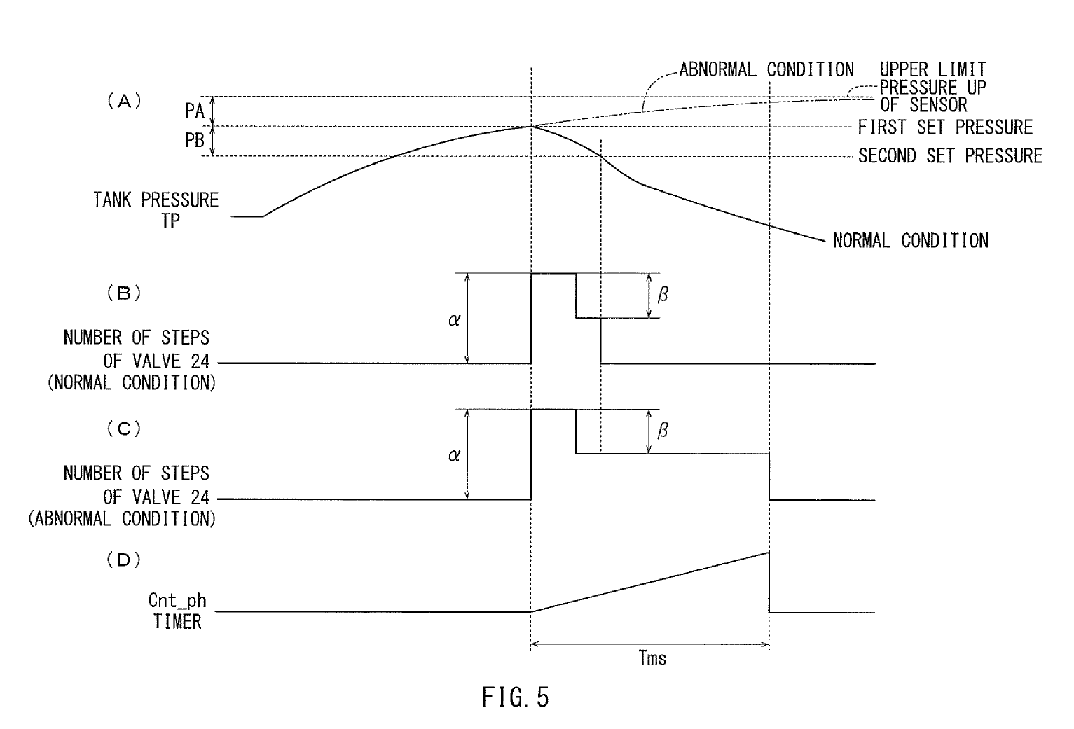

According to the process shown in FIG. 3, if the internal pressure of the fuel tank 15 increases to a pressure that is higher than the first set pressure value as shown in a portion (A) in FIG. 5 showing the change of the detected pressure PT with time, the number of steps of the step motor of the opening and closing valve 24 may be increased by the first predetermined number α, so that the opening and closing valve 24 may be fully opened. After that, the valve opening degree may be reduced by the second predetermined number β. Therefore, it may be possible to prevent the internal pressure of the fuel tank 15 from abnormally increasing. Normally, a pressure regulating valve (not shown) communicating within the fuel tank 15 may be opened to release the internal pressure of the fuel tank 15 to the atmosphere before the internal pressure abnormally increases. However, if the pressure regulating valve accidentally does not operate to release the tank internal pressure, the tank internal pressure may be increased. However, because the opening and closing valve 24 is opened as described above, it may be possible to prevent the internal pressure of the fuel tank 15 from abnormally increasing to exceed an upper limit value that may be determined according to the design of the fuel tank 15. When the tank internal pressure has been decreased to be lower than the second set pressure value, the number of steps of the step motor of the opening and closing valve 24 may be returned to the original number of steps. By reducing the tank internal pressure from the first set pressure value to the second set pressure value, it may be possible to inhibit a so-called hunting phenomenon. The hunting phenomenon may occur when the internal pressure fluctuates from a target pressure during the control. In the case of this embodiment, there are incorporated the first set pressure value for starting opening of the opening and closing valve 24 and the second set pressure value for decreasing the tank internal pressure before returning to the original degree of opening of the opening and closing valve 24. Because the first set pressure value and the second set pressure value are different from each other, it may be possible to give a hysteresis to the control for opening the closure valve 24 for preventing the hunting phenomenon. In other words, by setting the first set pressure value and the second set pressure value, a hysteresis control of the opening and closing valve 24 may be enabled with respect to the opening operation.

In this embodiment, the pressure sensor 26 may have a detectable range between the upper limit pressure value UP and a lower limit pressure value. The upper limit pressure value UP is shown in the portion (A) of FIG. 5. Preferably, the detectable range may be set to be narrower than a possible variable range of the internal pressure of the fuel tank 15 during the normal use. By setting the detectable range of the pressure sensor 26 in this way, it may be possible to improve the resolution for a frequently used intermediate pressure range of the internal pressure while the internal pressure in a high pressure ranger and a low pressure range that are not frequently used may not be detected. Therefore, it is not necessary to use a full-scale sensor as the pressure sensor 26. As a result, it is possible to save the cost for the pressure sensor 26. In this embodiment, the first set pressure value and the second set pressure value are determined to be smaller than the upper limit pressure value UP of the pressure sensor 26. Therefore, the internal pressure of the fuel tank 15 may not exceed the upper limit pressure value UP. In the case that the internal pressure of the fuel tank 15 is allowed to exceed the upper limit pressure value UP, a complicated control of the fuel injection valve 13 may be necessary. Thus, if the internal pressure of the fuel tank 15 exceeds the upper limit pressure value UP or becomes lower than the lower limit pressure value, it is no longer possible to control the fuel injection valve 13 by using the tank internal pressure as a parameter. In such a case, it may be necessary to use the other control parameter than the tank internal pressure, resulting in that the control of the fuel injection valve 13 is complicated. In this way, according to this embodiment, it is possible to avoid such a complicated control of the fuel injection valve 13.

Although the first set pressure value and the second pressure set value are determined in relation to the upper limit pressure value UP of the pressure sensor 26, a third set pressure value and a fourth set pressure value may be determined in relation to the lower limit pressure value of the pressure sensor 26. The third set pressure value and the fourth set pressure value may be larger than the lower limit pressure value by a third set value and a fourth set value. The third set pressure value may be used for fully opening the closure valve 24 in a manner similar to Step S5. The fourth pressure value may be used for stabilizing the tank internal pressure in a manner similar to Step S6. Therefore, when the internal pressure has decreased to be lower than the third set pressure value, the opening and closing valve 24 may be fully opened, and after that, the tank internal pressure may be increased to the fourth pressure value before returning to the original degree of opening. Also with this arrangement, it may be possible to prevent the hunting phenomenon of the control.

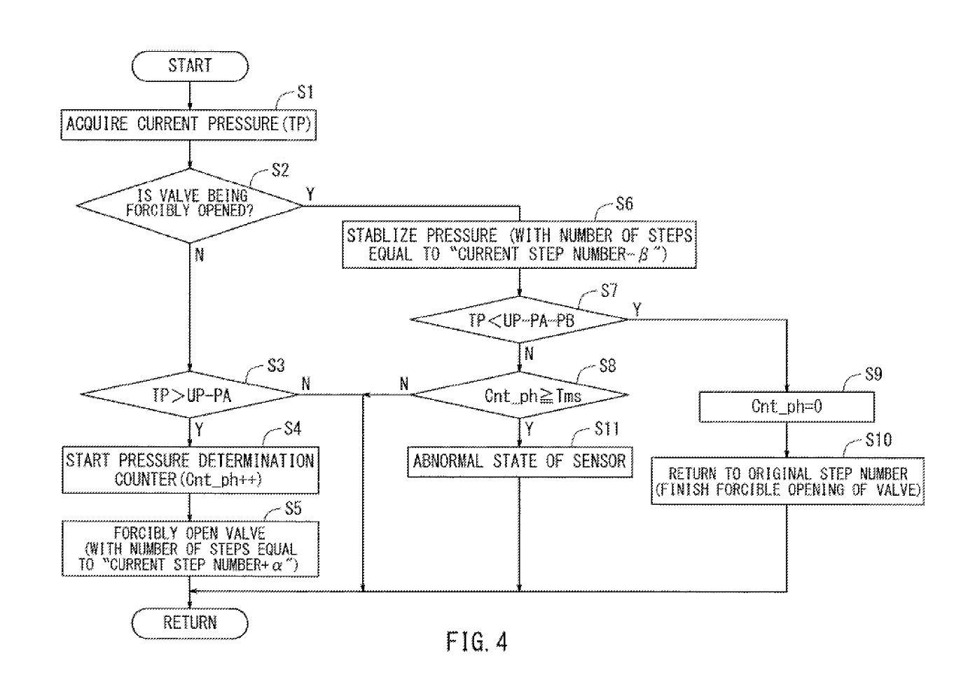

A second embodiment will now be described with reference to FIG. 4. The second embodiment is a modification of the first embodiment and is different from the first embodiment only in that the valve opening/closing control of the opening and closing valve 24 may be performed according to a valve opening process routine shown FIG. 4 that is a modification of that shown in FIG. 3. In FIG. 4, like steps are labeled with the same reference signs as those shown in FIG. 3.

In the valve opening process routine shown FIG. 4, the pressure value TP of the current pressure detected by the pressure sensor 26 may be acquired in Step S1. Next, in Step S2, it is determined whether or not a forcible valve opening operation is being performed. If the determination is “NO”, the process proceeds to Step S3 in which it is determined whether or not the detection value TP of the current pressure larger is than the first set pressure. If the determination in Step S3 is “YES”, the process proceeds to Step S4, in which a pressure determination counter Cnt starts to count up. Then, the process proceeds to Step S5 in which the opening and closing valve 24 is forcibly opened. After the opening and closing valve 24 has been forcibly opened, in the next cyclic process, the process proceeds from Step S2 to Step S6 in which the valve opening amount of the opening and closing valve 24 may be reduced by a small value for stabilizing the internal pressure of the fuel tank 15. After that, the process proceeds to Step S7 in which it is determined whether or not the pressure value TP detected by the pressure sensor 26 is smaller than the second set pressure value that is a subtraction of the sum of the first predetermined value PA and the second predetermined value PB from the upper limit value UP. If the determination in Step S7 is “NO”, the process proceeds to Step S8, in which it is determined whether or not the time counted by the pressure determination counter Cnt has elapsed a predetermined time T(ms). As long as the predetermined time T has not elapsed, the determination in Step S8 becomes “NO” and the process returns to start the next cyclic process. If the time T has elapsed in Step S8, the determination in Step S8 becomes “YES”, and the process proceeds to Step S11 in which it is determined that the pressure sensor 26 is not properly operating (i.e., a failure has occurred in the pressure sensor 26). More specifically, if the opening and closure valve 24 has been fully opened in response to increase of the pressure value TP to exceed the first set pressure value, the pressure value TP may decrease as shown in the portion (A) of FIG. 5. The predetermined time T may be determined to be long enough to allow the internal pressure of the fuel tank 15 to become lower than the second pressure value in the normal condition. After the predetermined time T has elapsed from opening of the opening and closing valve 24 as show in a portion (D) in FIG. 5 showing the change of the counted number of the counter Cnt with time T, if the pressure value TP has not become lower than the second set pressure value as indicated by a two-dot chain line in the portion (A) of FIG. 5, it is determined that a failure has occurred in the pressure sensor 26 in Step S11 and the number of steps of the step motor of the opening and closing valve 24 may be returned to the original number of steps. On the other hand, if the detected pressure TP of the fuel tank 15 has become lower than the second set pressure in Step S7, the process proceeds to Step S9 in which the counter Cnt is cleared. Thereafter, the process proceeds to Step S10 where the number of steps of the opening and closing valve 24 may be returned to the original step number before being changed in Step S5. In this way, as shown in the portion (A) and a portion (B) in FIG. 5 showing the change of the number of steps with time, if the detected pressure TP of the fuel tank 15 has become lower than the second set pressure value after the opening and closing valve 24 has been forcibly opened, it may be determined that the pressure sensor 26 is properly operating and the process shown in FIG. 4 may be finished. If the pressure sensor 26 is not properly operating, it may be possible that the detected value TP does not change with time. In this case, even in the event that the determination in Step S3 has become “YES” to the result that the opening and closing valve 24 is opened in Step S5 and the valve opening amount of the opening and closing valve 24 is reduced by a small value in Step S6 in the next process routine, the determination in Step S7 may not become “YES” in Step. Therefore, as shown in a portion (C) of FIG. 5 that shows the change of the number of steps of the step motor of the opening and closing valve 24 with time when the pressure sensor 26 does not properly operate (abnormal state), the number of steps of the step motor of the opening and closing valve 24 may not be returned to the original number of steps until the predetermine time T elapses.

According to the process shown in FIG. 4, if the detected pressure TP of the fuel tank 15 increases to a pressure that is higher than the first set pressure value as shown in the portion (A) in FIG. 5, the number of steps of the step motor of the opening and closing valve 24 may be increased by the first predetermined number α as shown in the portion (B) in FIG. 5, so that the opening and closing valve 24 may be fully opened. After that, the valve opening degree may be reduced by the second predetermined number β. Therefore, also in this embodiment, it may be possible to prevent the internal pressure of the fuel tank 15 from abnormally increasing. In addition, according to the second embodiment, it may be possible to determine whether or not the pressure sensor 26 is properly operating based on the detected pressure TP of the internal pressure of the fuel tank 15 after opening of the closure valve 24.

Also in the second embodiment, the first set pressure value and the second set pressure value are determined to be smaller than the upper limit pressure value UP of the pressure sensor 26. Therefore, it may be possible to efficiently determine whether or not the pressure sensor 26 is properly operating. For example, if the first set pressure value is determined to be equal to the upper limit pressure value UP, the opening and closing valve 24 may be opened when the detected pressure TP of the fuel tank 15 becomes equal to or higher than the upper limit pressure value UP. Although the internal pressure of the fuel tank 15 may decrease after that, the pressure sensor 26 may not be able to detect the internal pressure unless the internal pressure decreases are equal to or lower than the upper limit pressure value UP. In other words, if the internal pressure of the fuel tank 15 exceeds the upper limit pressure value UP, the internal pressure is out of a detectable range of the pressure sensor 26, and it is not possible to perform the determination in Step S7 until the internal pressure decreases to be equal to or lower than the upper limit pressure value UP. In the case of the second embodiment, the first set pressure value is determined to be smaller than the upper limit pressure value UP. Therefore, if the pressure sensor 26 is properly operating, the pressure sensor 26 can detect the internal pressure of the fuel tank 15 without delay after the opening and closing valve 24 has been fully opened. As a result, it is possible to quickly determine whether or not the pressure sensor 26 is properly operating.

The above discussion may be also applied to the case where the third set pressure value and the fourth set pressure value are determined in relation to the lower limit pressure value of the pressure sensor 26 as described in connection with the first embodiment. Thus, the third set pressure value and the fourth set pressure value may be larger than the lower limit pressure value by the third set value and the fourth set value, respectively.

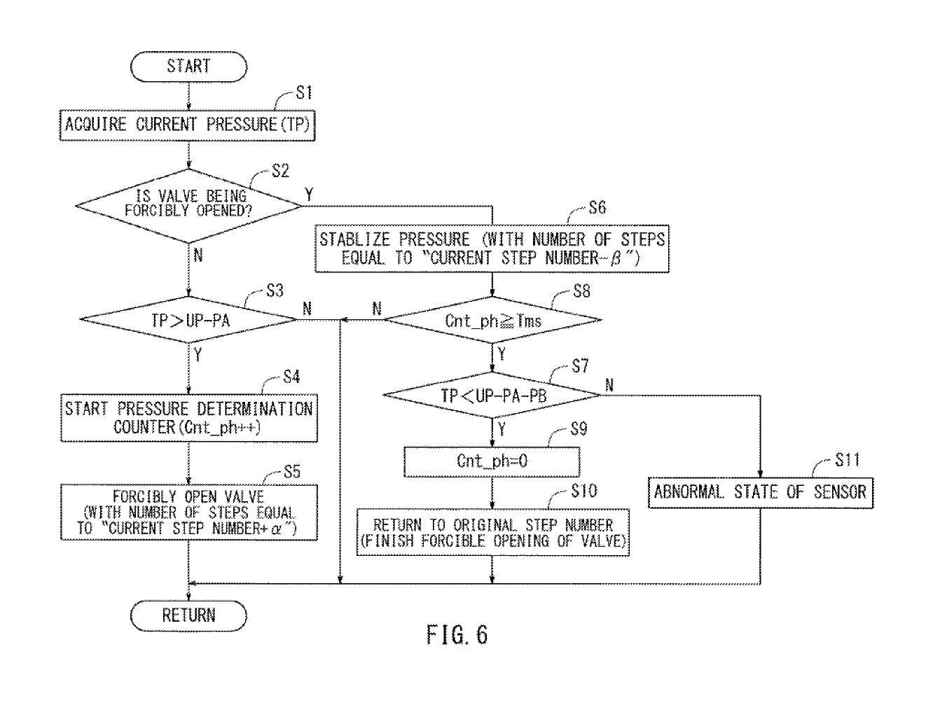

A third embodiment will now be described with reference to FIG. 6. The third embodiment is a modification of the second embodiment and is different from the second embodiment only in that the valve opening/closing control of the opening and closing valve 24 may be performed according to a valve opening process routine shown FIG. 6 that is a modification of that shown in FIG. 4. Therefore, in FIG. 6, like steps are labeled with the same reference signs as those shown in FIG. 4.

The valve opening process routine shown FIG. 6 is different from that shown in FIG. 4 only in that Step S8 is executed before Step S7. In other respects, the process routine shown in FIG. 6 is the same as that shown in FIG. 4. According to the process routine shown in FIG. 6, Step S7 may not be executed unless the predetermined time T has elapsed in Step S8. Therefore, the determination as to whether or not the pressure sensor 26 properly operates may be made only after the predetermined time T has elapsed.

In FIG. 3 of the first embodiment, FIG. 4 of the second embodiment, and FIG. 6 of the third embodiment, the processes executed in Steps S1, S2, S3, S5, S6, S7 and S10 may serve as control processes for opening the opening and closing valve 24. In other words a part of the control program stored in the memory of the ECU 16 for executing Steps S1, S2, S3, S5, S6, S7 and S10 may serve as a valve opening device. The processes executed in Steps S4, S7, S8 S9 and S11 serve as control process for determining whether or not the pressure sensor 26 is properly operating. In other words a part of the control program stored in the memory of the ECU 16 for executing Steps S4, S7, S8 S9 and S11 may serve as a failure determination device.

The above embodiments may be modified in various ways. For example, although the above embodiments were described in connection with the fuel vapor processing apparatus 10 used for the vehicle engine system 10, the above teachings may be also applied to any other engine systems other than those of vehicles. Further, the vehicle engine system 10 may be that of a hybrid automobile having an electric motor as a drive source in addition to an engine.

Representative, non-limiting examples were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved fuel vapor processing apparatus, and methods of making and using the same.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A fuel vapor processing apparatus for use with an engine system including an engine body and a fuel tank, the fuel vapor processing apparatus comprising:
a canister configured to adsorb fuel vapor;
a vapor passage connecting the canister and the fuel tank, so that fuel vapor produced in the fuel tank is adsorbed by the canister via the vapor passage;
a purge passage connecting the canister and the engine body, so that fuel vapor adsorbed from the canister is purged to the engine body via the purge passage;
an opening and closing valve disposed in the vapor passage and configured to open and close the vapor passage;
a pressure sensor coupled to the fuel tank and configured to detect an internal pressure of the fuel tank; and
a valve opening device coupled to the opening and closing valve and configured to open the valve when the internal pressure of the fuel tank detected by the pressure sensor has reached a first set pressure value;
wherein the first set value is determined to avoid potential damage to the fuel tank.

2. The fuel vapor processing apparatus according to claim 1, further comprising a failure determination device configured to determine whether or not the pressure sensor is properly operating; wherein:
the failure determination device determines that the pressure sensor is properly operating if a detected pressure of the pressure sensor has changed to decrease a difference between the detected pressure and an atmospheric pressure in response to opening of the opening and closing valve by the valve opening device; and
the failure determination device determines that the pressure sensor is not properly operating if the detected pressure of the pressure sensor has not changed to decrease the difference between the detected pressure and the atmospheric pressure in response to opening of the opening and closing valve by the valve opening device.

3. The fuel vapor processing apparatus according to claim 1, wherein:
the pressure sensor has a detectable range between an upper limit value and a lower limit value;
the first set pressure is determined to be within the detectable range and is not equal to the upper limit value and the lower limit value.

4. The fuel vapor processing apparatus according to claim 3, further comprising a failure determination device configured to determine whether or not the pressure sensor is properly operating, wherein:
the failure determination device determines that the pressure sensor is properly operating if a detected pressure of the pressure sensor has changed from a second set pressure to decrease a pressure difference between the detected pressure and an atmospheric pressure when a predetermined time has elapsed after the opening and closing valve has been opened;
the failure determination device determines that the pressure sensor is not properly operating if the detected pressure of the pressure sensor has not changed from the second set pressure to decrease the pressure difference between the detected pressure and the atmospheric pressure when the predetermined time has elapsed after the opening and closing valve has been opened; and
the second set pressure is nearer to the atmospheric pressure than the first set pressure.

5. The fuel vapor processing apparatus according to claim 1, further comprising a controller coupled to the pressure sensor and the opening and closing valve, wherein the controller comprises the valve opening device.

6. The fuel vapor processing apparatus according to claim 2, further comprising a controller coupled to the pressure sensor and the valve, wherein the controller comprises the failure determination device.

7. The fuel vapor processing apparatus according to claim 4, further comprising a controller coupled to the pressure sensor and the valve, wherein the controller comprises the valve opening device and the failure determination device.

8. A fuel vapor processing apparatus for use with an engine system including an engine body and a fuel tank, the fuel vapor processing apparatus comprising:
a canister configured to adsorb fuel vapor;
a vapor passage connecting the canister and the fuel tank, so that fuel vapor produced in the fuel tank is adsorbed by the canister via the vapor passage;
a purge passage connecting the canister and the engine body, so that fuel vapor adsorbed from the canister is purged to the engine body via the purge passage;
a pressure sensor coupled to the fuel tank and configured to detect an internal pressure of the fuel tank; and
a pressure releasing device coupled to the vapor passage and configured to release an internal pressure of the fuel tank via the vapor passage in response to a detected pressure of the pressure sensor.

9. The fuel vapor processing apparatus according to claim 8, wherein:
the pressure releasing device comprises:
an opening and closing device disposed in the vapor passage and configured to open and close the vapor passage;
a controller coupled to the pressure sensor and the opening and closing device and configured to actuate the opening and closing device to open the vapor passage when the detected pressure of the pressure sensor is higher than a predetermined maximum set value or lower than a predetermined minimum set value.

10. The fuel vapor processing apparatus according to claim 9, wherein:
the pressure sensor has a detectable range between an upper limit value and a lower limit value;
the predetermined maximum set value is lower than the upper limit value; and
the predetermined minimum set value is higher than the lower limit value.
